(19) United States
(12) Patent Application Publication
(10) Pub. No.: US 2024/0399340 A1
(43) Pub. Date: Dec. 5, 2024

(54) CATALYST COMPRISING A DOPED SULPHATED ZIRCONIUM OXIDE

(71) Applicant: IFP ENERGIES NOUVELLES, Rueil-Malmaison (FR)

(72) Inventors: Souad RAFIK-CLEMENT, Rueil-Malmaison Cedex (FR); Olivier DELPOUX, Rueil-Malmaison Cedex (FR); Gerhard PIRNGRUBER, Rueil-Malmaison Cedex (FR); Anne-Agathe QUOINEAUD, Rueil-Malmaison (FR); Robin CHAL, Rueil-Malmaison (FR)

(73) Assignee: IFP ENERGIES NOUVELLES, Rueil-Malmaison (FR)

(21) Appl. No.: 18/702,479

(22) PCT Filed: Oct. 11, 2022
(86) PCT No.: PCT/EP2022/078205

§ 371 Date: Apr. 18, 2024

(30) Foreign Application Priority Data
Oct. 19, 2021 (FR) FR2111093

(51) Int. Cl. B01J 21/06; B01J 6/00; B01J 21/04; B01J 23/42; B01J 27/02; B01J 35/00; B01J 35/61; B01J 37/02; B01J 37/04; B01J 37/12

(52) U.S. Cl. CPC B01J 21/066; B01J 6/001; B01J 21/04; B01J 23/42; B01J 27/02; B01J 35/19; B01J 35/615; B01J 37/0201; B01J 37/04; B01J 37/12

(57) ABSTRACT

The present invention relates to a catalyst comprising: (a) an aluminium-doped sulphated zirconium oxide, —with an aluminium content of 0.8 to 3.0% by weight of the catalyst, —with a cristallographic phase containing at least 80%, in particular at least 85% or at least 90%, of zirconium oxide in the tetragonal phase, —with a crystallinity index for the zirconium oxide of at least 55%, in particular of at least 60% or at least 65% or 70%; (b) a refractory oxide selected from silica and/or alumina; (c) a group VIIIB metal.

### TECHNICAL FIELD

The present invention relates to the field of hydrocarbon conversion, and notably the conversion of saturated hydrocarbons. It more particularly relates to the isomerization of light paraffins having from 4 to 12 carbon atoms. The invention thus relates to the catalyst used to promote this conversion, to the process for producing the catalyst and to the use thereof in an isomerization process.

### PRIOR ART

The isomerization of linear paraffins is a process that is widely used to improve the octane number of a naphtha hydrocarbon cut. Various catalyst compositions suitable for isomerization reactions of this type are known.

Thus, patent U.S. Pat. No. 5,036,035 describes a catalyst for the isomerization of paraffinic hydrocarbons which comprises sulfate in SO₄ form and at least one group VIII metal, on a support consisting of oxides and hydroxides of metals from groups IV and III. Some examples illustrate this type of composition, such as compositions of Pd SO₄/ZrO₂, Pt SO₄/ZrO₂ or else Pt SO₄ SiO₂—Al₂O₃ type. However, it was found that this type of composition lead to catalysts that are not very active and not very stable over time.

A catalyst is also known from patent application US 2003/0050523 that comprises a support made of sulfated oxide or hydroxide of a group IVB element, to which an element from the lanthanide family, notably ytterbium, and platinum are added. Ytterbium is a rare and expensive element, and this type of catalyst does not have a high activity.

Also known from the publication by GAO et al. (GAO Zi; XIA Yongde; HUA Weiming; MIAO Changxi (1998) New Catalyst of SO4₂₋/Al₂O₃—ZrO₂ of n-butane isomerization, in: Topics in Catalysis, Vol. 6, No. 1, p. 101106. DOI: 10.1023/A: 1019122608037) is a study on catalysts based on sulfated zirconias containing an aluminum promoter, recommended in the study for enhancing the activity and stability of catalysts for n-butane isomerization at low temperature in the absence of hydrogen. However, it should be noted that the performance tests were carried out on powders, not on the final catalysts after shaping, and that their performance on hydrocarbons heavier than butane were not evaluated.

For the purposes of the present invention, the various embodiments presented may be used alone or in combination with each other, without any limit to the combinations.

For the purposes of the present invention, the various ranges of parameters for a given step, such as the pressure ranges and the temperature ranges, can be used alone or in combination. For example, for the purposes of the present invention, a preferred range of pressure values can be combined with a range of more preferred temperature values.

In the remainder of the text, the groups of chemical elements are given according to the CAS classification (CRC Handbook of Chemistry and Physics, published by CRC Press, editor-in-chief D. R. Lide, 81st edition, 2000-2001). For example, group VIII according to the CAS classification corresponds to the metals from columns 8, 9 and 10 according to the new IUPAC classification, and group VIB corresponds to the metals from column 6.

In the text hereinbelow, the expressions “of between . . . and . . . ” and “between . . . and . . . ” are equivalent and mean that the limit values of the interval are included in the described range of values. Should such not be the case and should the limiting values not be included in the range described, such a clarification will be provided by the present invention.

### SUMMARY OF THE INVENTION

The objective of the invention is then to provide a new catalyst suitable for the isomerization of saturated C4-C12 hydrocarbons, which is more efficient. The objective is notably the development of such catalysts, which are more active, while remaining stable and selective.

A first subject of the invention is a catalyst comprising:
(a) an aluminum-doped sulfated zirconium oxide,
   with an aluminum content of from 0.8% to 3.0% by weight of the catalyst,
   with a crystallographic phase wherein the proportion of tetragonal phase zirconium oxide is at least 80%, notably at least 85% or at least 90%,
   with a crystallinity index of the zirconium oxide of at least 55%, notably of at least 60% or of at least 65% or 70%,
(b) a refractory oxide chosen from silica and/or alumina, preferably alumina or an alumina-silica mixture and/or alumina,
(c) a group VIIIB metal.

Throughout the present text:

The term “support” refers to the mixture consisting of sulfated zirconium oxide (a) and at least the aluminum dopant, and of a refractory oxide (b) preferably chosen from a silica-alumina mixture or alumina which is shaped, preferably by kneading/extrusion. and more generally the oxides to which one or more active metals are then added, for instance here a platinum group metal.

The term “catalyst” refers to the previously defined support to which the group VIIIB metal (c), such as platinum, is added.

“The crystallinity index” is defined by the ratio of the area measured between 10° and 70° 20 for the signal corresponding to the crystalline phases to the total area including the crystalline phase and the amorphous phase (it should be noted that this calculation is performed by calculation methods/software known to those skilled in the art).

The term “zirconia” should be understood as being synonymous with zirconium oxide.

The catalyst according to the invention is therefore in the form of an active phase based on sulfated zirconia of particular crystallographic characteristics, which is doped with aluminum in a very specific content, to which is added a refractory oxide which will serve as binder, to constitute the support, and to which is finally added a group VIIIB metal, such as platinum, to constitute the catalyst (irrespective of the order in which and the manner in which these various compounds are introduced).

The catalyst is advantageously free of elements from the lanthanide family.

Such a catalyst has been shown to have a high activity and a high stability for the isomerization of C4-C12, notably C4-C7, notably C5+ light paraffins: it thus has an activity and stability that are at least equivalent to those of catalysts known to those skilled in the art, notably comprising dopants which are considerably rarer and more expensive than aluminum, such as elements from the lanthanide family. Specifically, it has been shown in the context of the present invention that the catalytic performance for the isomerization of C4-C7 light paraffins is intimately related to a balance between the dopant content, sulfate content, zirconia crystallinity index and proportion of tetragonal phase in the support, leading to an optimal content of surface oxygen vacancies relative to the catalytic activity of the catalyst: it is by selecting particular values for these four characteristics in particular that an efficient catalyst was able to be obtained.

According to a variant of the invention, the sulfated zirconium oxide may also be doped with yttrium, notably in a content of from 0.5% to 1.5% by weight of the catalyst. In fact in some cases, and depending notably on the aluminum content used, a second dopant may be added, preferably in a lower weight content. Preferably, the total amount of doping agents added, Al+Y, is between 0.8 wt % and 3 wt %. In this variant, the Al/Y weight ratio is preferably at least equal to 1, notably greater than 1, preferably greater than or equal to 1.5.

According to the invention, the SO₃ content of the catalyst is preferably at least 2.5% by weight of the catalyst, notably between 2.5% and 8% by weight or between 2.5% and 9% by weight. Below the lower limit content, the catalytic activity may be reduced. Above the upper limit content, it may become more difficult to stabilize the sulfates in the material.

According to the invention, the sulfate content in the aluminum-doped sulfated zirconium oxide is at least 5% by weight of said oxide, notably at least 7% by weight, preferably between 7% and 11% by weight of said oxide.

Preferably, the surface density of sulfate in the catalyst according to the invention is between 1.0 SO₄²⁻/nm² and 6 SO₄²⁻/nm² or 1.0 SO₄²⁻/nm² and 5 SO₄²⁻/nm².

Advantageously, the content of superacid Zr³⁺ sites of the doped sulfated zirconium oxide is at least 0.16 mmol of Zr³⁺ per gram of the sum of (a) the doped sulfated zirconium oxide and (b) the refractory oxide, and notably between 0.16 and 0.3 mmol of Zr³⁺ per gram of the two oxides (a) and (b). It will be noted that the sum of these two oxides corresponds to the catalyst support. As detailed below, this content is obtained with measurements which are carried out here on the support (a)+ (b) of the catalyst, namely the combination of the doped sulfated zirconia and the refractory oxide. It is then possible to deduce therefrom, where appropriate, the content of Zr³⁺ sites per gram of doped sulfated zirconia (a).

The content of superacid Zr³⁺ sites (Zr) is understood to mean the amount of vacancies associated with g-factors such as:

$${g}_{xx} = {g}_{y y} = 1.9 \; 784 and {g}_{z z} = 1 \text{.9288}$$

$$and {g}_{xx} = {g}_{y y} = 1.9 \; 784 and {g}_{z z} = 1.9 \; 060$$

$$or {g}_{xx} = {g}_{y y} = 1.9 \; 768 and {g}_{z z} = 1.9589$$

and corresponding to the Zr³⁺ species per gram of support.

The amount of vacancies is determined according to a calibration method known to those skilled in the art. The reference compound used is 2,2-diphenyl-1-picrylhydrazyl (2,2-DPPH). The g-factors are explained below.

To determine this contents, the inventors used a known method for characterizing and quantifying oxygen vacancies, which is electron paramagnetic resonance (EPR). EPR is a spectroscopy specific to paramagnetic species, that is to say, species which contain unpaired electrons, as is the case for zirconium species close to oxygen vacancies. It is known to those skilled in the art that EPR makes it possible to identify the nature of the paramagnetic species by measuring the resonance frequency (called the g factor) and to quantify this species (in terms of numbers of spins per gram relative to a reference material analyzed under the same conditions). This technique has the advantage of being very sensitive and can therefore detect traces of the order of ppm. Numerous publications (such as Chavez J R, Devine R A B, Koltunski L, J. Appl. Phys., 2001; 90:4284; Foster A S, Sulimov V B, Gejo F L, Shluger A L, Nieminen R M, Phys. Rev. B, 2001; 64:224108; Foster A S, Gejo F L, Shluger A L, Nieminen R M, Phys. Rev. B, 2002; 65:174117) have performed theoretical calculations on zirconium oxide ZrO2 and show that the major defects of this oxide are oxygen vacancies, and interstitial oxygen atoms that can trap charges. According to this same literature, calculations show that some of these defects may contain unpaired electrons and therefore may be detectable by EPR. It is noted that this unpaired electron will not remain at the vacancy but will populate the 4d¹ level of the zirconium ion, reducing it to the (III) oxidation state. Thus, the defects are observed indirectly through the signature of Zr³⁺.

The inventors have thus shown that, surprisingly, the good performance of their catalyst corresponds to a minimum content of Zr³⁺ sites of 0.16 mmol: this content would be the “translation” of the amount of vacancies in sulfated zirconium oxide, which are highly favorable to its catalytic activity.

Preferably, the content of (b) refractory oxide, notably aluminum oxide and/or silicon oxide, is between 10% and 40% by weight of the catalyst, and very preferably between 15% and 25% by weight of the catalyst. When the oxide comprises aluminum oxide (alumina), it is preferably incorporated into the catalyst being prepared in the form of boehmite.

Preferably, the (c) group VIIIB metal is a platinum group element, notably Pt or Pd, preferably Pt. More preferably, its content is between 0.15% and 0.35% by weight of the catalyst.

Advantageously, the weight of the doped sulfated zirconium oxide (a) in the catalyst is chosen from at least 60% by weight, notably between 75% and 85% by weight.

Preferably, the S_BET specific surface area of the catalyst is at least 130 m²/g, notably at least 150 m²/g, preferably between 150 and 180 m²/g. Specifically, it has proved advantageous for the catalyst to have this specific surface area in order to have a good catalytic activity.

Another subject of the invention is a process for preparing the catalyst as described above and which comprises the following steps:
(1) preparing sulfated zirconium oxide doped with aluminum and optionally also with yttrium,
(2) mixing the doped sulfated zirconium oxide prepared in step (1) with at least one refractory oxide chosen from silica and/or alumina, or a precursor of at least one of these oxides, which mixing is performed notably by mixing powders in a solvent,
(3) shaping the mixture obtained in step (2), notably by extrusion,
(4) calcining the mixture shaped in step (3),
(5) impregnating the mixture calcined in step (4) with a precursor of the group VIIIB metal,
(6) calcining the mixture impregnated in step (5).

According to one embodiment of the process of the invention, step (1) of preparing the aluminum-doped sulfated zirconium oxide may comprise a sub-step (1.2) of calcining said oxide.

According to one embodiment of the process of the invention, the mixing step (2) ends with a sub-step of calcining the mixture before shaping, preferably at a temperature above the calcining temperature of step (4) of calcining the shaped mixture.

According to one embodiment of the process of the invention, the step (1) of preparing the doped sulfated zirconium oxide comprises a sub-step (1.1) of incorporating aluminum, and optionally yttrium when it is present in the catalyst, into the sulfated zirconium oxide by mixing the oxide with an aluminum precursor, and optionally also with an yttrium precursor. The two precursors can be added at the same time when yttrium and aluminum are incorporated, or they can be added sequentially, one after the other.

Another subject of the invention is the use of the catalyst described above in a process for isomerization of a hydrocarbon feedstock.

The invention also has a process for isomerizing at least one alkane or cycloalkane contained in a hydrocarbon feedstock having a final boiling point below or equal to 230° C., such that said process is carried out in the vapor or liquid phase, at a temperature of between 120° C. and 190° C., at a pressure of between 20 and 80 MPa, at a hydrogen/hydrocarbon compounds mole ratio of between 0.1 and 10, at an hourly space velocity HSV of between 0.05 and 15 h⁻¹, and with a catalyst as described above, and notably in oxysulfate form comprising
(a) an aluminum-doped sulfated zirconium oxide,
   with an aluminum content of from 0.8% to 3.0% by weight of the catalyst,
   with a crystallographic phase wherein the proportion of tetragonal phase zirconium oxide is at least 80% notably at least 85% or at least 90%,
   with a crystallinity index of the zirconium oxide of at least 55%, notably of at least 60% or of at least 65% or 70%,
(b) a refractory oxide chosen from silica and/or alumina,
(c) a group VIIIB metal.

### DESCRIPTION OF THE EMBODIMENTS

The invention will be described in detail below using nonlimiting embodiments and examples.

### Definitions

The weight percentages are expressed relative to the anhydrous weight of the final composite material. This anhydrous weight is determined by measuring said loss on ignition (LOI) corresponding to the weight variation resulting from heating the sample at 1000° C. for 2 h. The loss on ignition is expressed as a weight percentage of the solids.

The specific surface area of the catalyst or of the support used for the preparation of the catalyst according to the invention is understood to mean the BET specific surface area determined by nitrogen adsorption in accordance with the ASTM D 3663-78 standard drawn up from the Brunauer-Emmett-Teller method described in the journal “The Journal of American Society”, 60, 309 (1938).

The crystallographic structure of the zirconium oxide is determined by the X-ray diffraction (XRD) technique. More specifically, the 20 line at 30.2° is associated with the tetragonal crystallographic form and the 20 line at 28.2° is associated with the monoclinic crystallographic form. The proportion of tetragonal crystallographic phase is determined by measurements of the intensities of the line at 30.2° 2θ and of the line at 28.2° 2θ, corrected by the I/Ic response coefficients (RIR, Reference Intensity Ratio, method known to those skilled in the art). The proportion is at least 0.80. The crystallinity index is defined by the ratio of the area measured between 10° and 70° 2θ for the signal corresponding to the crystalline phases to the total area including the crystalline phase and the amorphous phase (this calculation is performed by software known to those skilled in the art). According to the invention, the crystallinity is preferably at least 55%, and notably greater than or equal to 60%, or even greater than or equal to 65%.

The degree of sulfate coverage is defined by the density of SO₄²⁻ sulfate ions at the surface of the zirconium oxide calculated as being the ratio between the number of SO₄²⁻ sulfate ions and the specific surface area of the support.

The content of superacid Zr³⁺ sites (Zr) is understood to mean the amount of vacancies associated with g-factors such as gₓₓ=g_{yy}=1.9784 and g_{zz}=1.9288 and gₓₓ=g_{yy}=1.9784 and g_{zz}=1.9060 or gₓₓ=g_{yy}=1.9768 and g_{zz}=1.9589 corresponding to the Zr³⁺ species per gram of support. The amount of vacancies is determined according to a calibration method well known to those skilled in the art. The reference compound used is 2,2-diphenyl-1-picrylhydrazyl (2,2-DPPH). The method has been described in detail above.

The invention relates to a catalyst based on an oxysulfate comprising (or consisting of) a sulfated zirconium oxide, doped with aluminum or with a mixture of aluminum and yttrium, an inorganic refractory oxide used as binder chosen from silica, alumina and silica-alumina, and a group VIII metal. The inventors have shown that the catalyst according to the invention has an activity and stability that are equivalent to those of chlorinated alumina reference catalyst as prepared according to patent WO 97/19752, the main drawback of which is that it involves the use of chlorine and leads to problems of corrosion of industrial units.

The active phase of the catalyst of the invention comprises (or consists of) an oxysulfate consisting of a sulfated zirconium oxide modified by doping with aluminum or with aluminum and yttrium.

The sulfated zirconium oxide is, for example, prepared from a sulfated zirconium hydroxide. A sulfated zirconium hydroxide marketed by Luxfer MEL Technologies, Flemington, NJ may be used in the context of the invention. Alternatively, the zirconium hydroxide can be prepared by precipitating an aqueous solution of zirconium salt such as ZrOCl₂·8H₂O, ZrCl₄, ZrONH₃ by adding a concentrated ammonia solution. The zirconium hydroxide sulfation step can be carried out in the liquid or gaseous phase by a sulfating agent such as H₂SO₄, (NH₄)₂SO₄, H₂S, SO₂, CS₂ according to protocols well known in the literature. Mention may notably be made of the following publications: TICHIT, D.; Coq, B.; Armendariz, H.; Figueras, F. (1996) One-step sol-gel synthesis of sulfated-zirconia catalysts. in: Catalysis Letters, vol. 38, no. 1-2, p. 109-113. DOI: 10.1007/BF00806908, TICHIT, D.; ELALAMI, D.; Figueras, F. (1996) Preparation and anion exchange properties of zirconia. in: Applied Catalysis A: General, vol. 145, no. 1-2, p. 195-210. DOI: 10.1016/0926-860X (96) 00171-8, Li, X.; Nagaoka, K.; Olindo, R.; Lercher, J. A. (2006) Synthesis of highly active sulfated zirconia by sulfation with SO 3. in: Journal of Catalysis, vol. 238, no. 1, p. 39-45. DOI: 10.1016/j.jcat.2005.11.039.

The sulfated zirconium hydroxide can be dried, before or after the step of doping with aluminum, or with aluminum and yttrium, without modification of its performance, at a temperature allowing evaporation of the volatile species. The XRD technique does not reveal the 2θ lines at 28.2° and at 30.2° which are characteristic of monoclinic and tetragonal zirconium oxide (tetragonal phase zirconia forming after calcination).

Aluminium is another important component of the catalyst of the invention. Aluminum is added to the sulfated zirconium hydroxide before the high-temperature calcining treatment, which makes it possible to obtain the crystalline zirconium oxide form. The aluminum is introduced in the ionic form A13+. Preferably, the aluminum precursors are in nitrate, carbonate, acetate, chloride, hydroxide, hydroxycarbonate, oxalate, sulfate or formate form, or in the form of complexes formed by a polyacid or an acid alcohol.

According to the invention, the content of Al dopant in the alumina-doped sulfated zirconium oxide is between 0.8% and 3% by weight of said oxide, preferably between 1% and 2.5% by weight of said oxide.

Additionally, optionally, the yttrium element may be present in a range of from 0.5% by weight to 1.5% by weight relative to the sulfated zirconium oxide, the Al/Y ratio is greater than 1, preferably the Al/Y ratio is less than 1.5, and the total amount of doping agents Al+Y is between 0.8% by weight and 3% by weight of the catalyst or between 1% by weight and 2.5% by weight of the catalyst.

The yttrium is introduced in Y³⁺ form. Preferably, the yttrium precursors are in nitrate, carbonate, acetate, chloride, hydroxide, hydroxycarbonate, oxalate, sulfate or formate form, or in the form of complexes formed by a polyacid or an acid alcohol.

The dopants (aluminum and optionally also yttrium) are incorporated into zirconium hydroxide, before or after sulfation, by any method known to those skilled in the art (dry impregnation or excess impregnation, coprecipitation, etc.)

The addition of yttrium can be carried out at the same time as or after the addition of aluminum, but advantageously, for the catalytic activity, before the high-temperature calcining treatment.

The doped sulfated zirconium hydroxide or doped sulfated zirconium oxide obtained previously are shaped, for example in the form of beads or extrudates, in the presence of a refractory inorganic binder chosen from silica, boehmite, alumina and silica-alumina. Preferably, the binder chosen is boehmite.

A high-temperature heat treatment should be carried out to obtain sulfated zirconium oxide in its tetragonal form. This high-temperature heat treatment can be carried out before or after shaping. If it is carried out before shaping, the temperature is preferentially between 650° C. and 750° C., preferentially between 670° C. and 725° C. The temperature is adjusted so as to obtain a proportion of at least 80% zirconium oxide in tetragonal crystallographic form according to the XRD characterization.

The content of aluminum element in the sulfated zirconium oxide is between 0.8% by weight and 3% by weight. The presence of aluminum in the crystallographic structure of the sulfated zirconium oxide is verified after the high-temperature calcining treatment by EPR.

The specific surface area of the sulfated zirconium hydroxide or oxide is between 80 m²/g and 400 m²/g and very preferably between 100 m²/g and 300 m²/g.

According to the invention, the sulfate content in the aluminum-doped sulfated zirconium oxide is at least 5% by weight of said oxide, notably at least 7% by weight, preferably between 7% and 11% by weight of said oxide.

The content of Zr³⁺ sites of the support is between 0.160 and 0.300 mmol Zr³⁺ per gram of support (a)+ (b).

The density of structural and surface defects is calculated as follows: after having determined the optimum acquisition conditions (that is to say within the linearity range of the detector), a calibration straight line is produced using various solutions of DPPH (2,2-diphenyl-1-picrylhydrazyl), the spin concentrations of which are known. To do this, these solutions are recorded under the same acquisition conditions as in the case of ZrO₂ and the resulting signal is double integrated. This mathematical processing can be carried out by numerous software programs known to those skilled in the art. Next, the EPR spectra of zirconium oxide are subtracted from the baseline and double integrated. The area is then plotted on the calibration straight line to make it possible to extract a number of spins per gram of sample. This number is then converted to vacancies since there is only one spin per defect.

The catalyst formulation may also comprise an organic adjuvant. It is advantageously chosen from cellulose derivatives, polyethylene glycols, aliphatic monocarboxylic acids, alkylated aromatic compounds, fatty acids, polyvinyl alcohol, methylcellulose, polyacrylates, polymethacrylates, polymers of polysaccharide type (such as xanthan gum), etc., taken alone or in a mixture.

This organic adjuvant may also be chosen from any additive known to those skilled in the art. Nitric acid (10M) can be added to ensure effective peptization of boehmite. Nitric acid combined with effective kneading has the effect of breaking up agglomerates and dispersing them on the nanoscale. This dispersion makes it possible to achieve a more homogeneous mixture between the material obtained previously in its doped sulfated zirconium hydroxide or doped sulfated zirconium oxide form and boehmite. During the preparation of the catalyst, notably when it involves one or more calcination steps, this adjuvant disappears and is therefore no longer present as such in the final catalyst.

The shape chosen for the shaping, generally beads or extrudates, has no impact on the performance or the characteristics of the catalyst according to the invention. The doped sulfated zirconium hydroxide or doped sulfated zirconium oxide is in the form of beads, extrudates or tablets according to the usual means described in the literature.

Preferably, the starting components/reactants for producing a final catalyst according to the invention may have the following characteristics/proportions:
1% to 99% by weight, preferably 5% to 99% by weight, preferably 10% to 99% by weight, and very preferably from 10% to 80% by weight of sulfated and doped zirconium hydroxide or sulfated and doped zirconium oxide,
1% to 99% by weight, preferably 1% to 50% by weight, preferably 10% to 40% by weight, and very preferably from 15% to 25% by weight of boehmite,
0% to 40% by weight, preferably 0% to 25% by weight, and very preferably from 3% to 15% by weight of nitric acid (concentration range 10M),
0% to 20% by weight, preferably 0% to 10% by weight, and very preferably from 0% to 7% by weight of at least one organic adjuvant, the weight percentages being expressed relative to the total weight of said material, and the sum of the contents of each of the compounds of said material being equal to 100%.

The process for preparing the catalyst according to the invention preferably comprises at least the following two steps, according to one embodiment:
a) a step of mixing a powder of doped sulfated zirconium hydroxide or doped sulfated zirconium oxide with a powder of a boehmite-type binder and at least one solvent in order to obtain a mixture,
b) a step of shaping the mixture obtained on conclusion of step a).

### Step a):

Step a) consists of the mixing a powder of doped sulfated zirconium hydroxide or doped sulfated zirconium oxide with a powder of a boehmite-type binder and at least one solvent in order to obtain a mixture,

Preferably, a boehmite source and optionally an organic adjuvant are also mixed during step a). Preferably, the boehmite source and optionally at least one organic adjuvant may be mixed in powder form or in solution in said solvent. Said solvent is preferably water.

The order in which the mixing of the powders of at least the doped sulfated zirconium hydroxide or doped sulfated zirconium oxide, of a refractory inorganic binder and optionally of at least one organic adjuvant (in the case where they are mixed in powder form) with at least one solvent is carried out is unimportant.

The mixing of said powders and of said solvent can advantageously be carried out all at once. The additions of powders and of solvent may also be advantageously alternated.

Preferably, said powders of at least one doped sulfated zirconium hydroxide or doped sulfated zirconium oxide, of a refractory inorganic binder and optionally of at least one organic adjuvant in the case where these are mixed in the form of powders, are first dry premixed, before introduction of the solvent, optionally in the presence of nitric acid.

Said premixed powders are then advantageously brought into contact with said solvent, optionally in the presence of nitric acid. The placing in contact with said solvent leads to the production of a mixture which is then kneaded.

Preferably, said mixing step a) is performed by batchwise or continuous kneading. In the case where said step a) is performed batchwise, said step a) is advantageously performed in a kneader, preferably equipped with Z-arms, or a cam mixer, or in any other type of mixer known. Said mixing step a) makes it possible to obtain a homogeneous mixture of the pulverulent constituents.

Preferably, said step a) is performed for a time of between 5 and 60 minutes, and preferably between 10 and 50 minutes. The rotational speed of the kneader arms is advantageously between 10 and 75 rpm, preferably between 25 and 50 rpm. The starting compounds/reactants listed above are introduced in step a).

### Step b)

Step b) consists of shaping the mixture obtained on conclusion of the mixing step a). Preferably, the mixture obtained on conclusion of the mixing step a) is advantageously shaped by extrusion. Step b) is advantageously carried out in a ram extruder, single-screw extruder or twin-screw extruder.

In this case, an organic adjuvant may optionally be added to the mixing step a). The presence of said organic adjuvant facilitates the shaping by extrusion. Said organic adjuvant is described above and is introduced in step a) in the proportions indicated above.

In the case where said preparation process is performed continuously, said mixing step a) may be coupled with step b) of shaping by extrusion in the same equipment. According to this embodiment, the extrusion of the mixture, also called “kneaded paste”, can be carried out either by directly extruding at the end of a twin-screw continuous kneader for example, or by connecting one or more batch kneaders to an extruder. The geometry of the die, which gives the extrudates their shape, can be chosen from dies well known to a person skilled in the art. They can thus, for example, be of cylindrical, multilobe, fluted or slotted shape.

During step b), the amount of solvent added in the mixing step a) is adjusted so as to obtain, on conclusion of this step and regardless of the variant implemented, a mixture or a paste which does not run but which is also not too dry, so as to allow its extrusion under suitable pressure conditions well known to those skilled in the art and dependent on the extrusion equipment used.

Preferably, said step b) of shaping by extrusion is performed at an extrusion pressure of greater than 1 MPa and preferably of between 3 MPa and 10 MPa.

### Step c)

The process for preparing said material also comprises a step c) of drying the shaped material obtained on conclusion of step b). Said drying step is advantageously performed at a temperature of between 0° C. and 300° C., preferably between 20° C. and 200° C. and preferably between 20° C. and 150° C., for a time of between 1 minute and 72 hours, preferably between 30 minutes and 72 hours, preferably between 1 hour and 48 hours and more preferably between 1 and 24 hours.

### Step d)

The material obtained at the end of step c), which will therefore constitute the support, can be calcined in a step d) at a temperature of between 600° C. and 800° C., preferably between 650° C. and 750° C., in air for a time of between 1 h and 6 h, preferably between 1 h and 2 h.

In the variant where the doped sulfated zirconium hydroxide or doped sulfated zirconium oxide is calcined before shaping to obtain the support, the calcination carried out on the material is performed at a temperature below the temperatures of 650-700° C. indicated above: it is preferably performed at a temperature of between 450° C. and 600° C. or between 450° C. and 550° C., in air for a time of between 1 h and 6 h, or between 1 h and 2 h.

The temperature and the duration of the calcining of the composite product are adjusted in order to obtain, in the final catalyst, a proportion of zirconium oxide of tetragonal crystallographic phase of at least 80%. The proportion of the crystalline phase is monitored by XRD, the 20 lines at 28.2° and at 30.2° being characteristic of the monoclinic and tetragonal zirconium oxide phases, respectively.

The specific surface area and the sulfate content are monitored according to characterization methods well known to those skilled in the art (respectively nitrogen physisorption and CHNS analysis for example).

A group VIII element, preferably Pt, is added by any means known in the literature (dry impregnation or excess impregnation). The final catalyst is calcined between 400° C. and 500° C. The content of group VIII element, preferably Pt, is between 0.15% by weight and 0.35% by weight relative to the final catalyst.

The catalyst according to the invention can be used in processes for isomerizing at least one alkane contained in a hydrocarbon feedstock containing from 4 to 12 carbon atoms, preferably a hydrocarbon feedstock containing from 4 to 7 carbon atoms, more preferentially a feedstock composed of a mixture of paraffins having 4 to 7 carbon atoms and cycloalkanes having 5 to 7 carbon atoms. Preferentially, the feedstock contains at least 50% by weight of linear paraffins. The feedstock may also contain olefins and aromatics, in general less than 15% by weight.

The process for isomerizing the hydrocarbon feedstock composed of a mixture of paraffins having 4 to 8 carbon atoms and cycloalkanes having 5 to 8 carbon atoms is carried out in the vapor or liquid phase at a temperature of between 100° C. and 250° C., preferably between 130° C. and 190° C. and more preferentially between 150° C. and 180° C., at a pressure of between 20 and 80 MPa, at a hydrogen/(paraffinic compounds to be isomerized) mole ratio of between 0.1 and 10 and at an hourly space velocity H.S.V. of between 0.05 and 15 h⁻¹.

Optionally, a step of drying the catalyst, once it has been produced, is carried out at a temperature below 250° C.

Advantageously, a step of heat treatment of the catalyst, once it has been produced, is carried out at a temperature below 250° C. in the presence of a reducing gas, preferably the reducing gas is dihydrogen. Preferably, the hydrogen flow rate, expressed in l/hour/gram of catalyst precursor is between 0.01 and 100 l/hour/gram of catalyst.

### EXAMPLES

### Example 1: Preparation of a Catalyst A Pt/S—Zr—Al₂O₃ (Comparative)

Catalyst A was prepared from a commercial sulfated zirconium hydroxide S—Zr(OH) supplied by Luxfer MEL Technologies, Flemington, NJ, under the reference XZO1247.

A support A is prepared by co-kneading a commercial sulfated zirconium hydroxide S—Zr(OH) and a boehmite suspended in an acidic aqueous solution, and then extruded, dried at 120° C. and then calcined at 700° C. for 2 hours. The final catalyst A is obtained by dry impregnation of the support A with a solution of Pt(NH₄)NO₃ and calcining at 450° C. The volume of the impregnation solution is equal to the pore volume. This example is comparative, since the sulfated zirconia is not doped with aluminum.

Table 1 below details the formulation and the characteristics of catalyst A.

TABLE 1
Example 1: Catalyst A

| | |
|---|---|
| tetragonal phase ZrO₂ | 95% |
| Crystallinity index | 83% |
| Al₂O₃ | 25.9 wt % |
| SO₃ | 3.3 wt % |
| dSO₄²⁻/nm² | 1.8 |
| Pt | 0.25 wt % |
| Content of Zr³⁺ sites (mmol/g of support) | 0.09 |
| S_BET | 140 m²/g |

### Example 2: Preparation of a Catalyst B Pt/Al₁—SZr—Al₂O₃ (According to the Invention)

Catalyst B was prepared from a commercial sulfated zirconium hydroxide S—Zr(OH) supplied by Luxfer MEL Technologies, Flemington, NJ, reference XZO1247, doped with an aluminum nitrate solution.

A support B is prepared by dry impregnation of a commercial sulfated zirconium hydroxide S—Zr(OH) with an aluminum nitrate solution. The concentration of aluminum in the impregnation solution is adjusted to reach 1 wt % of aluminum in catalyst B. The volume of the aluminum nitrate solution is equal to the pore volume. The aluminum-doped sulfated zirconium hydroxide Al₁—SZr(OH) is co-kneaded with a boehmite suspended in an acidic aqueous solution, and then extruded and dried at 120° C., and then calcined at 650° C. for 2 hours. The final catalyst B according to the invention is obtained by dry impregnation of the support B with a solution of Pt(NH₄)NO₃ and calcining at 450° C. The volume of the impregnation solution is equal to the pore volume. Table 2 below details the formulation and the characteristics of catalyst B.

TABLE 2
Example 2: Catalyst B

| Zr(OH)Al₁ | | |
|---|---|---|
| % Al | 1 | wt % |
| % Zr tetragonal phase ZrO₂ | 98% | |
| Crystallinity index | 81% | |
| Al₂O₃ | 22.9 | wt % |
| SO₃ | 2.75 | wt % |
| dSO₄²⁻/nm² | 1.4 | |
| Pt | 0.25 | wt % |
| Content of Zr³⁺ sites (mmol/g of support) | 0.165 | |
| S_BET | 160 | m²/g |

### Example 3: Preparation of a Catalyst C Pt/Al₁Y_{0.5}—SZr(OH)—Al₂O₃ (According to the Invention)

Catalyst C was prepared from a commercial sulfated zirconium hydroxide S—Zr(OH) supplied by Luxfer MEL Technologies, Flemington, NJ, reference XZO1247, doped with a solution of aluminum nitrate and yttrium nitrate.

A support C is prepared by dry impregnation of a commercial sulfated zirconium hydroxide S—Zr(OH) with a solution of aluminum nitrate and yttrium nitrate. The concentrations of aluminum and yttrium in the impregnation solution are adjusted to reach 1 wt % of aluminum and 0.5 wt % of yttrium in catalyst C. The volume of the solution of aluminum nitrate and yttrium nitrate is equal to the pore volume. The sulfated zirconium hydroxide doped with aluminum and yttrium Al₁Y_{0.5}—SZr(OH) is co-kneaded with a boehmite suspended in an acidic aqueous solution, and then extruded and dried at 120° C., and then calcined at 650° C. for 2 hours. The final catalyst C according to the invention is obtained by dry impregnation of the support C with a solution of Pt(NH₄)NO₃ and calcining at 450° C. The volume of the impregnation solution is equal to the pore volume. Table 3 below details the formulation and the characteristics of catalyst C.

TABLE 3
Example 3: Catalyst C

| Zr(OH)Al₁Y_{0.5} | | |
|---|---|---|
| % Al | 1 | wt % |
| % Y | 0.5 | wt % |
| % Zr tetragonal phase ZrO₂ | 90% | |
| Crystallinity index | 79% | |
| Al₂O₃ | 18.6 | wt % |
| SO₃ | 2.8 | wt % |
| dSO₄²⁻/nm² | 1.4 | |
| Pt | 0.25 | wt % |
| Content of Zr³⁺ sites (mmol/g of support) | 0.190 | |
| S_BET | 160 | m²/g |

### Example 4: Preparation of a Catalyst D Pt/Al_{2.5}—SZr—Al₂O₃ (According to the Invention)

Catalyst D was prepared from a commercial sulfated zirconium hydroxide S—Zr(OH) supplied by Luxfer MEL Technologies, Flemington, NJ, reference XZO1247, doped with an aluminum nitrate solution.

A support D is prepared by co-kneading a commercial sulfated zirconium hydroxide S—Zr(OH) and a boehmite suspended in an acidic aqueous solution, and then extruded and dried at 120° C., dry impregnated with an aluminum nitrate solution, then calcined at 700° C. for 2 hours. The concentration of aluminum in the impregnation solution is adjusted to reach 2.5 wt % of aluminum in catalyst D. The final catalyst D is obtained by dry impregnation of the support D with a solution of Pt(NH₄)NO₃ and calcining at 450° C. The volume of the impregnation solution is equal to the pore volume. Table 4 below details the formulation and the characteristics of catalyst D.

TABLE 4
Example 4: Catalyst D

| Zr(OH)Al_{2.5} | | |
|---|---|---|
| % Al | 2.5% | |
| % Zr tetragonal phase ZrO₂ | 90% | |
| Crystallinity index | 78% | |
| Al₂O₃ | 23.5 | wt % |
| SO₃ | 3.1 | wt % |
| dSO₄²⁻/nm² | 1.4 | |
| Pt | 0.25 | wt % |
| Content of Zr³⁺ sites (mmol/g of support) | 0.261 | |
| S_BET | 170 | m²/g |

### Example 5: Preparation of a Catalyst E Pt/Al_{0.5}—SZr—Al₂O₃ (Comparative)

Catalyst E was prepared from a commercial sulfated zirconium hydroxide S—Zr(OH) supplied by Luxfer MEL Technologies, Flemington, NJ, reference XZO1247, doped with an aluminum nitrate solution.

A support E is prepared by dry impregnation of a commercial sulfated zirconium hydroxide S—Zr(OH) with an aluminum nitrate solution. The concentration of aluminum in the impregnation solution is adjusted to reach 0.5 wt % of aluminum in catalyst E. The volume of the aluminum nitrate solution is equal to the pore volume. The aluminum-doped sulfated zirconium hydroxide Al_{0.5}—SZr(OH) is co-kneaded with a boehmite suspended in an acidic aqueous solution, and then extruded, dried at 120° C., and then calcined at 650° C. for 2 hours. The final catalyst E according to the invention is obtained by dry impregnation of the support E with a solution of Pt(NH₄)NO₃ and calcining at 450° C. The volume of the impregnation solution is equal to the pore volume. This example is comparative, since it has an insufficient aluminum content (and also too low a content of Zr³⁺ sites).

Table 5 below details the formulation and the characteristics of catalyst E.

TABLE 5
Example 5: Catalyst E

| Zr(OH)Al_{0.5} | | |
|---|---|---|
| % Al | 0.5 | wt % |
| % Zr tetragonal phase ZrO₂ | 95% | |
| Crystallinity index | 80% | |
| Al₂O₃ | 25.0 | wt % |
| SO₃ | 2.9 | wt % |
| dSO₄²⁻/nm² | 1.5 | |
| Pt | 0.25 | wt % |
| Content of Zr³⁺ sites (mmol/g of support) | 0.128 | |
| S_BET | 140 | m²/g |

### Example 6: Preparation of a Catalyst F Pt/Al_{2.5}—SZr—Al₂O₃ (According to the Invention)

Catalyst F was prepared from a commercial sulfated zirconium hydroxide S—Zr(OH) supplied by Luxfer MEL Technologies, Flemington, NJ, reference XZO1247, doped with an aluminum nitrate solution according to the protocol of example D.

A support F is prepared by co-kneading a commercial sulfated zirconium hydroxide doped with 2.5 wt % of aluminum Al—S—Zr(OH) calcined at 700° C. and a boehmite suspended in an acidic aqueous solution, and then extruded, dried at 120° C. and then calcined at 550° C. for 2 hours. The final catalyst F is obtained by dry impregnation of the support F with a solution of Pt(NH₄)NO₃ and calcining at 450° C. The volume of the impregnation solution is equal to the pore volume. Table 6 below details the formulation and the characteristics of catalyst F.

TABLE 6
Example 6: Catalyst F

| Zr(OH)Al_{2.5} | | |
|---|---|---|
| % Al | 2.5% | |
| % Zr tetragonal phase ZrO₂ | 90% | |
| Crystallinity index | 70% | |
| Al₂O₃ | 21.3 | wt % |
| SO₃ | 6.1 | wt % |
| dSO₄²⁻/nm² | 2.7 | |
| Pt | 0.25 | wt % |
| Content of Zr³⁺ sites (mmol/g of support) | 0.245 | |
| S_BET | 172 | m²/g |

### Example 7: Preparation of a Catalyst G Pt/Al₁—SZr—Al₂O₃ (Comparative)

Catalyst G was prepared from a commercial sulfated zirconium hydroxide S—Zr(OH) supplied by Luxfer MEL Technologies, Flemington, NJ, reference XZO1247, doped with an aluminum nitrate solution.

A support G is prepared by co-kneading a commercial sulfated zirconium hydroxide S—Zr(OH) and a boehmite suspended in an acidic aqueous solution, and then extruded and dried at 120° C. and then calcined at 700° C. for 2 hours. The support G is then dry impregnated with an aluminum nitrate solution. The concentration of aluminum in the impregnation solution is adjusted to reach 1 mol % of aluminum in catalyst G. The final catalyst G is obtained by dry impregnation of the support G with a solution of Pt(NH₄)NO₃ and calcining at 450° C. The volume of the impregnation solution is equal to the pore volume. This example is comparative because it has notably a percentage % Zr tetragonal phase ZrO₂ that is too low. Table 7 below details the formulation and the characteristics of catalyst G.

TABLE 7
Catalyst G

| Zr(OH)Al₁ | | |
|---|---|---|
| % Al | 1 | wt % |
| % Zr tetragonal phase ZrO₂ | 70% | |
| Crystallinity index | 76% | |
| Al₂O₃ | 23.3 | wt % |
| SO₃ | 3.1 | wt % |
| dSO₄²⁻/nm² | 1.44 | |
| Pt | 0.25 | wt % |
| Content of Zr³⁺ sites (mmol/g of support) | 0.151 | |
| S_BET | 162 | m²/g |

### Example 8: Preparation of a Catalyst H Pt/Al_{2.5}—SZr—Al₂O₃ (Comparative)

Catalyst H was prepared from a commercial sulfated zirconium hydroxide S—Zr(OH) supplied by Luxfer MEL Technologies, Flemington, NJ, reference XZO1247, doped with an aluminum nitrate solution according to the protocol of example D.

A support H is prepared by co-kneading a commercial sulfated zirconium hydroxide doped with 2.5 wt % of aluminum Al—S—Zr(OH) calcined at 650° C. and a boehmite suspended in an acidic aqueous solution, and then extruded, dried at 120° C. and then calcined at 550° C. for 2 hours. The final catalyst H is obtained by dry impregnation of the support H with a solution of Pt(NH₄)NO₃ and then calcining at 450° C. The volume of the impregnation solution is equal to the pore volume. This example is comparative, since the crystallinity index of the zirconia of 50% is too low, as is its content of Zr³⁺ sites.

Table 8 below details the formulation and the characteristics of catalyst H.

TABLE 8
Example 8: Catalyst H

| Zr(OH)Al_{2.5} | | |
|---|---|---|
| % Al | 2.5% | |
| % Zr tetragonal phase ZrO₂ | 90% | |
| Crystallinity index | 50% | |
| Al₂O₃ | 21.1 | wt % |
| SO₃ | 2.9 | wt % |
| dSO₄²⁻/nm² | 1.1 | |
| Pt | 0.25 | wt % |
| Content of Zr³⁺ sites (mmol/g of support) | 0.140 | |
| S_BET | 197 | m²/g |

### Example 9: Preparation of a Catalyst I Pt/Al_{2.5}—SZr—Al₂O₃ (Comparative)

Catalyst I was prepared from a commercial sulfated zirconium hydroxide S—Zr(OH) available from Luxfer MEL Technologies, Flemington, NJ, under the commercial reference XZO1247, doped with an aluminum nitrate solution according to the protocol of example D.

A support I is prepared by co-kneading a commercial sulfated zirconium hydroxide doped with 2.5 wt % of aluminum Al—S—Zr(OH) calcined at 800° C. and a boehmite suspended in an acidic aqueous solution, and then extruded, dried at 120° C. and then calcined at 550° C. for 2 hours. The final catalyst I is obtained by dry impregnation of the support I with a solution of Pt(NH₄)NO₃ and then calcining at 450° C. The volume of the impregnation solution is equal to the pore volume.

This example is comparative, since the residual sulfur content is too low.

Table 9 below details the formulation and the characteristics of the catalyst.

TABLE 9
Example 9: Catalyst I

| Zr(OH)Al_{2.5} | | |
|---|---|---|
| % Al | 2.5% | |
| % Zr tetragonal phase ZrO₂ | 90% | |
| Crystallinity index | 87% | |
| Al₂O₃ | 21 | wt % |
| SO₃ | 1.2 | wt % |
| dSO₄²⁻/nm² | 0.8 | |
| Pt | 0.25 | wt % |
| Content of Zr³⁺ sites (mmol/g of support) | 0.140 | |
| S_BET | 110 | m²/g |

### Example 10: Preparation of a Catalyst J Pt/Al_{2.5}—SZr—Al₂O₃ (Comparative)

Catalyst J was prepared from a commercial sulfated zirconium hydroxide S—Zr(OH) available from Luxfer MEL Technologies, Flemington, NJ, under the commercial reference XZO1247, doped with an aluminum nitrate solution according to the protocol of example D.

A support J is prepared by co-kneading a commercial sulfated zirconium hydroxide doped with 2.5 wt % of aluminum Al—S—Zr(OH) calcined at 700° C. and a boehmite suspended in an acidic aqueous solution, and then extruded, dried at 120° C. and then calcined at 700° C. for 2 hours. In this example, the following are therefore performed on the support: a pre-calcining (on powder), a shaping (extruded), a drying and then a post-calcining.

The final catalyst J is obtained by dry impregnation of the support J with a solution of Pt(NH₄)NO₃ and then calcining at 450° C. The volume of the impregnation solution is equal to the pore volume.

This example is comparative, since the residual sulfur content is too low, which low content is found to be linked to carrying out a double hi-temperature calcination of the support, and more particularly a post-calcination (after extrusion and drying) at too high a temperature. It is therefore preferable, in the case of a double calcination, to choose for the second calcination a temperature lower than the first calcination.

Table 10 below details the formulation and the characteristics of the catalyst.

TABLE 10
Example 10: Catalyst J

| Zr(OH)Al_{2.5} | | |
|---|---|---|
| % Al | 2.5% | |
| % Zr tetragonal phase ZrO₂ | 90% | |
| Crystallinity index | 70% | |
| Al₂O₃ | 21.2 | wt % |
| SO₃ | 1.1 | wt % |
| dSO₄²⁻/nm² | 0.7 | |
| Pt | 0.25 | wt% |
| Content of Zr³⁺ sites (mmol/g of support) | 0.140 | |
| S_BET | 120 | m²/g |

### Example 11: Isomerization of a C5/C6/C7 Cut

Around 20 g of the catalysts A to J prepared are charged to a fixed-bed reactor. The catalysts are dried under a stream of nitrogen at 400° C. and then feedstock into the reactor in a glove box. The catalyst is reduced under a stream of H₂ at 160° C. for 2 h.

The test is carried out at 40 bar and a temperature of 160° C., with an H2/hydrocarbon mole ratio of 4. The feedstock is a mixture containing 29.5% by weight of n-pentane, 33.9% by weight of n-hexane, 5.6% by weight of n-heptane, 5.5% by weight of C5 naphthene, 25.2% by weight of C6 naphthene. The mass flow rate is 1.3 g feedstock (g catalyst)⁻¹ h⁻¹.

Table 11 below brings together the results of catalytic activity of examples 1 to 8 corresponding to the catalysts A to H. They are expressed as
% iC5/C5: the weight ratios of isopentane to the sum of all the pentanes (iC5/C5)
% 22DMB/C6: the ratio of 2,2-dimethylbutane to the sum of the paraffins with 6 carbon atoms (22DMB/C6), obtained in the conversion of a synthetic feedstock in a fixed bed, at set operating conditions.

An increase in these ratios expresses an increase in octane number (also known as the RON or Research Octane Number).

It should be noted that the accuracy of the measurement of the iC5/C5 ratio is ±2% (absolute) at iC5/C5=65% and ±4% at iC5/C5=45%.

To evaluate the stability of the catalysts, the two ratios are compared after 5 and 160 h under feedstock. If the catalyst is stable, the two ratios decrease very little over time.

TABLE 11

| | % iC5/C5 | % 22DMB/C6 | % iC5/C5 | 22DMB/C6 |
|---|---|---|---|---|
| | After 5 hours | After 5 hours | After 160 hours | After 160 hours |
| Catalyst | (% mol/mol) | (% mol/mol) | (% mol/mol) | (% mol/mol) |
| Catalyst A (comparative) | 40.4 | 13.3 | 30.2 | 10.5 |
| Catalyst B (invention) | 73.6 | 29.1 | 73.3 | 29.0 |
| Catalyst C (invention) | 75.3 | 33.8 | 75.5 | 33.7 |
| Catalyst D (invention) | 61.5 | 25.8 | 61.5 | 25.8 |
| Catalyst E (comparative) | 48.2 | 12.1 | 35.5 | 10.2 |
| Catalyst F (invention) | 63.8 | 23.8 | 63.5 | 23.7 |
| Catalyst G (comparative) | 53 | 21 | 45 | 12 |
| Catalyst H (comparative) | 44.0 | 18.3 | 43.0 | 18.0 |
| Catalyst I (comparative) | 30.4 | 10.5 | 28.0 | 9.8 |
| Catalyst J (comparative) | 37.0 | 12.4 | 35.9 | 12.0 |

It is seen from these results that the results in terms of % iC5/C5 at 5 hours are from at least 61.5 (catalyst D according to the invention) up to 75.3 (catalyst C according to the invention), whereas these same results are at most 53 (comparative catalyst G): the invention therefore makes it possible to improve the activity of the catalyst by at least 23%.

The results expressed in terms of % 22DMB/C6 at 5 hours go in the same direction.

The remarkable stability of the % iC5/C5 and % 22DMB/C6 values of the examples according to the invention, with the values measured at 160 hours being virtually unchanged relative to the values measured at 5 hours, should also be noted.

1. A catalyst comprising:
(a) an aluminum-doped sulfated zirconium oxide,
with an aluminum content of from 0.8% to 3.0% by weight of the catalyst,
with a crystallographic phase wherein the proportion of tetragonal phase zirconium oxide is at least 80%,
with a crystallinity index of the zirconium oxide of at least 55%,
(b) a refractory oxide chosen from silica and/or alumina, and
(c) a group VIIIB metal.

2. The catalyst as claimed in claim 1, wherein the sulfated zirconium oxide (a) is also doped with yttrium.

3. The catalyst as claimed in claim 1, wherein the Al/Y weight ratio is at least equal to 1.

4. The catalyst as claimed in claim 1, wherein the sulfate content of the catalyst is at least 2.5% by weight of the catalyst.

5. The catalyst as claimed in claim 1, wherein the sulfate content in the aluminum-doped sulfated zirconium oxide (a) is at least 5% by weight of said oxide.

6. The catalyst as claimed in claim 1, wherein the content of superacid Zr³⁺ sites of the doped sulfated zirconium oxide is at least 0.16 mmol of Zr³⁺ per gram of the sum of (a) the doped sulfated zirconium oxide and (b) the refractory oxide.

7. The catalyst as claimed in claim 1, wherein the content of refractory oxide (b) is between 10% and 40% by weight of the catalyst.

8. The catalyst as claimed in claim 1, wherein the group VIIIB metal (c) is a platinum group element.

9. The catalyst as claimed in claim 1, wherein the weight of the doped sulfated zirconium oxide (a) in the catalyst is at least 60% by weight.

10. The catalyst as claimed in to claim 1, wherein the S_BET specific surface area of the catalyst is at least 130 m²/g.

11. A process for preparing the catalyst as claimed in claim 1, said process comprising:
(1) preparing sulfated zirconium oxide doped with aluminum and optionally also with yttrium,
(2) mixing the doped sulfated zirconium oxide prepared in step-(1) with at least one refractory oxide chosen from silica and/or alumina, or a precursor of at least one of these oxides,
(3) shaping the mixture obtained in (2),
(4) calcining the mixture shaped in (3),
(5) impregnating the mixture calcined in (4) with a precursor of the group VIIIB metal, and
(6) calcining the mixture impregnated in (5).

12. The process as claimed in claim 11, wherein the preparing of the aluminum-doped sulfated zirconium oxide (1) comprises calcining said oxide.

13. The process as claimed in claim 11, the mixing (2) ends with a sub-step of calcining the mixture before shaping.

14. The process as claimed in claim 11, wherein the preparing of the doped sulfated zirconium oxide comprises incorporating aluminum and optionally yttrium into the sulfated zirconium oxide by mixing the oxide with an aluminum precursor and optionally also with an yttrium precursor.

15. (canceled)

16. A process for isomerizing at least one alkane contained in a hydrocarbon feedstock having a final boiling point below or equal to 230° C., said process comprising:
isomerizing said hydrocarbon feedstock in the vapor or liquid phase, at a temperature of between 120° C. and 190° C., at a pressure of between 20 and 80 MPa, at a hydrogen/paraffinic compounds mole ratio of between 0.1 and 10 and at an hourly space velocity HSV of between 0.05 and 15 h⁻¹, in the presence a catalyst
according to claim 1.

17. The catalyst as claimed in claim 1, wherein the aluminum-doped sulfated zirconium oxide (a) has a crystallographic phase wherein the proportion of tetragonal phase zirconium oxide is at least 85%, a crystallinity index of the zirconium oxide of at least 60%, and the refractory oxide (b) is alumina or an alumina-silica mixture.

18. The catalyst as claimed in claim 2, wherein the aluminum-doped sulfated zirconium oxide (a) has a content of from 0.5% to 1.5% by weight of the catalyst.

19. The catalyst as claimed in claim 1, wherein the Al/Y weight ratio is greater than or equal to 1.5.

20. The catalyst as claimed in claim 1, wherein the sulfate content of the catalyst is between 2.5% and 9% by weight.

21. The catalyst as claimed in claim 1, wherein the sulfate content of the aluminum-doped sulfated zirconium oxide (a) is between 7% and 11% by weight of said oxide.
